(19) United States
(12) Patent Application Publication
(10) Pub. No.: US 2009/0207039 A1
(43) Pub. Date: Aug. 20, 2009

(54) CEC CONTROL APPARATUS

(75) Inventor: Toshio HAIJIMA, Tokyo (JP)

Correspondence Address: DARBY & DARBY P.C., P.O. BOX 770, Church Street Station, New York, NY, 10008-0770, US

(73) Assignee: SMK CORPORATION, Tokyo (JP)

(21) Appl. No.: 12/243,013

(22) Filed: Oct. 1, 2008

(30) Foreign Application Priority Data
Feb. 18, 2008 (JP) 2008-035994

(51) Int. Cl. G05B 19/02

(52) U.S. Cl. 340/825.22

(57) ABSTRACT

A Consumer Electronics Control (CEC) control apparatus includes a vendor code acquisition instruction unit that queries a CEC device for a vendor code when connected to a CEC device, a control part provided with a storage unit capable of storing the reference location of stored CEC control information that corresponds to the acquired vendor code, a control information storage part which, for each vendor, pre-stores CEC control information corresponding to a plurality of vendors, and a photoreceptor unit having a received signal demodulation unit capable of receiving a signal from a remote control RC and demodulating the signal to acquire a CEC control signal. Based on the acquired vendor information, the control part acquires from the control information storage part control information corresponding to the vendor corresponding to the control signal transmitted from the remote control RC, and outputs the CEC control signal to the externally connected CEC device.

### CROSS-REFERENCE TO RELATED APPLICATION

This application claims the benefit under 35 U.S.C. §119 of Japanese Patent Application No. 2008-035994, filed on Feb. 18, 2008, which is hereby incorporated by reference herein in its entirety.

### FIELD OF THE INVENTION

The present invention relates to a versatile CEC (Consumer Electronics Control) control apparatus that uses CEC commands to operate electronic products complying with high-definition multimedia standards.

### BACKGROUND OF THE INVENTION

At present, a high-definition multimedia interface (hereafter simply referred to as HDMI) exists as a standard for controlling a wide variety of AV devices, such as LCD televisions, audio devices, and the audio and video recording devices connected thereto and used therewith.

HDMI has already been standardized, and consumer electronics control (hereafter simply referred to as CEC) is one part of that standard (see, e.g., High-Definition Multimedia Interface Specification Version 1.3a, HDMI Licensing, LLC, Nov. 10, 2006). With CEC, commands are defined for controlling the power supply or operation of a home electronics product, and with a video record- and playback-capable DVD player, for example, control commands such as playback and video record are defined in addition to ON and OFF commands for the power supply.

Moreover, the CEC command-based control of AV devices is implemented via a remotely-operable remote control apparatus.

Using the example of a DVD player, CEC command-based control is explained below for the state in which the DVD player is connected to a television and controlled with CEC commands via the television.

In the conventional example shown in FIG. 3, an LCD television 100 and a DVD player 101 are connected by an HDMI connection cord 102. The LCD television 100 and the DVD player 101 are both provided with control functions based on HDMI standard CEC commands, and comply with the CEC standard. The LCD television 100 and the DVD player 101 may for example be products made by different manufacturers.

Reference numeral 104 denotes a receiver unit capable of receiving control signals sent from a remote controller 103, converting them into control signals that comply with the CEC standard, and transmitting them via the HDMI connection cord to the connected LCD television 100, the DVD player 101, or the like.

In this conventional example, for explanatory purposes, the receiver unit 104 is configured separately from the LCD television 100 and the DVD player 101, each of which are described as being controlled according to control signals received from the remote controller 103; however, the receiver unit 104 may commonly be provided with built-in devices that comply with the CEC standard, or the receiver unit 104 may alternatively be used in an embodiment connected via a USB to a personal computer system.

The receiver unit 104 as depicted in FIG. 3 has a control part 106, and also has a receiving part 105 that accepts signals from the remote controller 103. Moreover, the receiver unit 104 also has a received signal demodulation part 108 that demodulates control signals received by the receiving part 105 and converts them into CEC standard-compliant CEC commands. The receiving part 105 is continuously standing-by to receive control signals, and when a control signal is received, the control part 106 causes the received signal demodulation part 108 to demodulate the received control signal, and then substitutes a CEC command and outputs the control signal as a CEC command.

Moreover, the receiver unit 104 is provided with a storage means 107 for storing CEC control information, and the storage means 107 stores CEC control information corresponding to a signal obtained from the control signal received from the remote controller 103 and then demodulated. The control part 106, based on the demodulated control signal, acquires corresponding CEC control information from the storage means 107, and outputs this information as a CEC command, via a HDMI connection cord 102 that includes a CEC connection, to a CEC device.

As information that complies with the CEC standard, a CEC standard-compliant device (hereafter simply referred to as a CEC device) contains vendor information for specifying the vendor who has manufactured a product and device classification information for specifying the class of the device itself.

On the other hand, among the CEC commands for implementing control in compliance with the CEC standard, there exist device control commands for controlling the CEC device, and specifically, these device control commands are used for performing such functions as turning ON and OFF the power supply, playing back and recording a DVD video, and so on. Device classification information is generally contained in these CEC commands themselves. There is also a vendor acquisition command for causing vendor information to be output. With CEC command-based control, a device control command is specified as combining vendor information and device classification information, and the command scheme will differ for each vendor and device.

Specifically, the device control commands for a DVD player made by Company A may differ from those for a DVD player made by Company B, and even if the DVD player made by Company B accepts a device control command for the DVD player made by Company A, the DVD player made by Company B will not operate.

Moreover, in a connection implemented via a HDMI connection cord that is compliant with the CEC standard, so that CEC control information or a CEC command is outputted to all connected CEC devices, the HDMI connection is implemented in a manner analogous to connecting a single signal line, whereby each CEC device is connected so as to be in parallel with the connection cord. Accordingly, a CEC command outputted from any location is accepted by all CEC devices, and if the CEC command corresponds to a particular device itself, operation based on this CEC command is performed, however if the CEC command does not correspond to the particular device itself, then the command is not recognized as control information and no operation is performed.

On the other hand, commands such as a device command or a vendor acquisition command, which are unrelated to individual control, are recognized at all CEC devices, and an operation is performed accordingly.

In the conventional connection of a CEC device as shown in FIG. 3, the CEC commands corresponding to the device vendor and provided in the receiver unit 104 itself are stored in the storage means 107. Accordingly, control signals are transmitted from the remote controller 103 to the receiver unit 104, and the receiving part 105 of the receiver unit 104 receives the control signals.

At the receiver unit 104, after receiving a control signal, the control part 106 sends the accepted control signal to the received signal demodulation part 108 where the received control signal is analyzed. Then, the received signal demodulation part 108 outputs the analyzed control signal to the control part 106 again. The control part 106 references the storage means 107 for CEC control information corresponding to the demodulated control signal, and loads in the corresponding CEC control information. Next, the control part 106 outputs the loaded-in CEC control information via the HDMI connection cord 102.

At this time, in the case where the control signal accepted from the remote controller 103 is for controlling the television 100, the CEC control information includes a device command that specifies the device to be controlled. The CEC device to be controlled by the device command recognizes that the specified device is itself, and controls itself so as to perform an operation corresponding to the device command. Similarly, in the case where the accepted control signal is for the DVD player 101, the CEC control information includes a device command for controlling the DVD player 101.

However, with the conventional control of a CEC device, only CEC control information corresponding to the vendor of the CEC device to which the receiver unit 104 is attached is stored in the storage means 107, and CEC device control is thereby limited to devices from the same vendor, i.e., devices from the same manufacturer and same series. As a result, versatility is lacking in the overall control of CEC devices.

Accordingly, a consumer is also limited to the same manufacturer and same series when purchasing a CEC device. Control of CEC devices from different manufacturers has been difficult to implement with a receiver unit 104 associated with a different CEC device. Similarly, in after some period of time, there was a problem in that even if a newly-purchased device is from the same manufacturer, the CEC control device commands may not correspond to the vendor, and device control becomes difficult to implement.

In particular, each household has a personal computer PC nowadays, and the implementation of CEC device control from the personal computer PC is desired. Even in this case, the device commands will end up corresponding to the vendor of the personal computer PC, and versatility in the CEC device control cannot be achieved.

### SUMMARY OF THE INVENTION

In consideration of the abovementioned problems, an object of the present invention is to provide a CEC control apparatus capable of controlling CEC devices from any vendor.

The present invention, in a first embodiment, provides:

a CEC control apparatus that receives a control signal transmitted from a remote controller, specifies a CEC device control signal from the received control signal, and is capable of communicating with a CEC device, the CEC control apparatus comprising:
a connecting interface for connecting to the CEC device so that CEC control signals can be exchanged;
a CEC modulation-demodulation unit capable of modulating and demodulating a CEC control signal that communicates with the CEC device to be controlled via the interface;
a vendor code acquisition instruction unit that queries the CEC device upon being connected for its vendor code and accepts the vendor code transmitted from the CEC device;
a control part provided with a storage unit capable of storing the acquired vendor code;
a control information storage part, connected so as to be able to exchange signals with the control part, and having pre-stored CEC control information for a plurality of vendors, each vendor being specified by a vendor code; a receiving unit, connected so as to be able to exchange signals with the control part, for receiving control signals transmitted from the remote controller; and
a photoreceptor unit comprising a received signal demodulation unit capable of accepting and demodulating control signals received by the receiving unit and acquiring CEC control signals;
the control part acquiring, based on the vendor code stored in the storage unit and control signal received by the photoreceptor unit, CEC control information corresponding to the CEC device to be controlled and stored in the control information storage part, modulating the CEC control information with the CEC modulation-demodulation unit, and being capable of transmitting the modulated CEC control information via the connecting interface to the CEC device.

In another embodiment, CEC control apparatus, for acquiring CEC control information, corresponding to the CEC device to be controlled that has been stored in the control information storage part based on the acquired vendor code and the received control signal, provides:

a CEC control apparatus that receives a control signal transmitted from a remote controller, specifies a CEC device control signal from the received control signal, and is capable of communicating with a CEC device, the CEC control apparatus comprising:
a connecting interface for connecting to the CEC device so that CEC control signals can be exchanged;
a CEC modulation-demodulation unit capable of modulating and demodulating a CEC control signal that communicates with the CEC device to be controlled via the interface;
a vendor code acquisition instruction unit that queries the CEC device upon being connected for its vendor code and accepts the vendor code transmitted from the CEC device;
a control part provided with a storage unit capable of storing the acquired vendor code; a control information storage part, connected so as to be able to exchange signals with the control part, and having pre-stored CEC control information for a plurality of vendors, each vendor being specified by a vendor code;
a receiving unit, connected so as to be able to exchange signals with the control part, for receiving control signals transmitted from the remote controller; and
a photoreceptor unit comprising a received signal demodulation unit capable of accepting and demodulating control signals received by the receiving unit and acquiring CEC control signals;
wherein at the control part, storing the acquired vendor code of a connected CEC device in the storage unit of the control part enables the corresponding CEC control information to be acquired from the control information storage part; and
wherein when the photoreceptor unit receives a control signal from the remote controller, demodulates the received signal, acquires a control signal, and outputs the control signal to the control part, based on the accepted control signal and the previously acquired and stored vendor code of the CEC device to be controlled, the control part selects and accepts from the control information storage part CEC control information corresponding to the CEC device to be controlled, modulates the CEC control information with the CEC modulation-demodulation unit, and is capable of transmitting the modulated CEC control information via the connecting interface to the CEC device.

The control part accepts a modulated control signal from the photoreceptor unit, and CEC control information stored in the control information storage part and corresponding (linked) to the previously acquired and stored vendor code of the CEC device to be controlled can be read out. Accordingly, at the CEC control apparatus, when the photoreceptor unit receives a control signal from the remote controller, the receiving unit detects and outputs the signal to the received signal demodulation unit. At the received signal demodulation means, the received control signal is demodulated, and control information is obtained and output to the control part.

At the control part, the vendor code is read out from the storage unit, and based on the read-out vendor code and the control signal accepted from the photoreceptor unit, the control information storage part is queried for stored CEC control information that corresponds to the read-out vendor code, and then CEC control information corresponding to the vendor code is loaded in from the control information storage part. Then, the loaded-in CEC control information is modulated by the transmission signal modulation unit that is capable of transmitting CEC control signals and transmitted via the connecting interface to the CEC device. Then, at the CEC device, since the CEC control information is the correct CEC control information corresponding to the vendor code, an action is performed based on the CEC control information.

In another embodiment, the present invention provides:

a CEC control apparatus that receives a control signal transmitted from a remote controller, specifies a CEC device control signal from the received control signal, and is capable of communicating with a CEC device, the CEC control apparatus comprising:
a connecting interface for connecting to the CEC device so that CEC control signals can be exchanged;
a vendor code acquisition instruction unit that queries the CEC device for the vendor code when the CEC device is connected, and accepts the vendor code transmitted from the CEC device;
a control part provided with a storage unit capable of storing the reference location for stored CEC control information that corresponds to the acquired vendor code;
a control information storage part, connected so as to be able to exchange signals with the control part, and having pre-stored CEC control information for a plurality of vendors, each vendor being specified by a vendor code;
a receiving unit, connected so as to be able to exchange signals with the control part, for receiving control signals transmitted from the remote controller;
a photoreceptor unit comprising a received signal demodulation unit capable of accepting and demodulating control signals received by the receiving unit and acquiring CEC control signals; and
a transmission signal modulation unit capable of transmitting CEC control signals; wherein

at the control part, by storing the storage site of the control information storage part, which records the CEC control information corresponding to the vendor specified by the vendor code acquired from the connected CEC device, in the storage unit of the control part, the corresponding CEC control information is set to be acquired from the control information storage part; and

when the photoreceptor unit receives a control signal from the remote controller, demodulates the received signal, acquires a CEC control signal, and outputs the CEC control signal to the control part, based on the accepted control signal and the previously acquired and stored vendor code of the CEC device to be controlled, the control part selects and accepts from the control information storage part CEC control information corresponding to the CEC device to be controlled, and is capable of transmitting the accepted CEC control information to via the connecting interface the CEC device.

Then, at the CEC control apparatus, when the CEC device is connected via a connecting interface, the vendor code acquisition instruction unit instructs the CEC device to output its vendor code. Based on this instruction, the vendor code is transmitted from the connected CEC device and is inputted into the control part.

The control part queries the control information storage part for the reference site, which is a storage area in the control information storage part that corresponds to the inputted vendor code, and stores the reference site in the storage unit. Thereafter, the reference site stored in the storage unit becomes the storage site of CEC control information corresponding to the vendor code.

When the photoreceptor unit receives a control signal from the remote controller, the receiving unit detects and outputs the signal to the received signal modulation-demodulation unit. The received signal modulation-demodulation means demodulates the received control signal, and obtains and outputs control information to the control unit.

At the control part, CEC control information corresponding to the control signal accepted from the photoreceptor unit is loaded in from a reference site stored in the storage unit. Then, the loaded-in CEC control information is transmitted via the connecting interface to the CEC device. Then, at the CEC device, since the CEC control information is the correct CEC control information corresponding to the vendor code, an action is performed based on the CEC control information.

### BRIEF DESCRIPTION OF THE DRAWINGS

The invention will became more readily apparent from the Detailed Description of the Invention which proceeds with reference to the drawings in which:

FIG. 1 provides a schematic diagram illustrating an embodiment of the present invention;

FIG. 2 provides a schematic diagram illustrating another embodiment of the present invention; and

FIG. 3 provides a schematic diagram showing conventional example of CEC command-based control.

### DETAILED DESCRIPTION OF THE INVENTION

The following table provides a legend for a number of reference elements applied in the drawings.

| MA | CEC device |
|---|---|
| IF | Interface |
| CA | HCMI cable |
| RC | Remote controller |
| 1 | CEC control apparatus |
| PC | Personal computer |
| 1a | CEC control apparatus main body |
| 2 | Photoreceptor unit |
| 21 | Photoreceiving part |
| 22 | Instruction signal decode part |
| 3 | Control part |
| 31 | Vendor code acquisition instruction unit |
| 32 | Storage unit |
| 33 | Control part main body |
| 34 | CEC modulation-demodulation unit |
| 4 | Control information storage part |

According to the present invention, CEC control information corresponding to a plurality of vendor codes is stored in correspondence with those vendor codes in a control information storage part, and therefore, even if there is a change in the CEC device connected to the CEC control apparatus, the vendor code of the connected CEC device may be acquired automatically and the CEC control information corresponding to that vendor code may be acquired from the control information storage means so that the CEC device can be controlled, thereby enabling highly versatile CEC device control that is not limited to a particular vendor. In the past, if the vendors were different and the same CEC control information was transmitted, the CEC device would not operate in some cases, but with the present invention, even if the vendors are different, operable CEC control information can be transmitted to each device.

Moreover, with the provision of this CEC control apparatus in a personal computer PC or the like, even if CEC controllable home electronics products are replaced, familiar operations can be performed with the same remote controller as had been used previously.

With reference to FIG. 2, CEC control apparatus 1 has a CEC interface IF capable of transmitting and receiving CEC control information and is connected to a CEC device MA. In one embodiment of the present invention, the CEC control apparatus 1 is USB-connected as an external device of the personal computer and functions as a part of the personal computer. Accordingly, the CEC control apparatus 1 is described below as a part of the personal computer.

The CEC control apparatus 1 is provided with a photoreceptor unit 2. The photoreceptor unit 2 has a photoreceiving part 21 capable of receiving optical control signals from a remote controller RC (hereafter referred to as the remote control RC), and an instruction signal decode part 22 which is an instruction signal demodulation unit capable of analyzing optical instructions received by the photoreceptor unit 2.

Moreover, the CEC control apparatus 1 is provided with a control information storage part 4. Control information corresponding to the control signal decoded at the photoreceptor unit 2 is stored in the control information storage part 4. This control information is information that enables control of the CEC device MA, and for each vendor specified by the vendor code of the CEC device MA, control information linked to that vendor code is stored in the control information storage part 4.

The photoreceptor unit 2 and the control information storage part 4 are connected to a control part 3, so as to be able to transfer information. The control part 3 is provided with a vendor acquisition instruction unit 31. The CEC control apparatus 1 is connected to the CEC device MA via the interface IF, and after the connection has been verified by a function provided in the CEC control standard, the vendor acquisition instruction unit 31 can query the connected CEC device MA for its vendor code. Accordingly, when a connection is formed with the CEC device MA, the vendor code is transmitted automatically from the connected CEC device MA and acquired at the control part 3. Then, the acquired vendor code is stored in a separately provided storage unit 32. When the vendor code has been stored, the storage unit 32 provided in the control part 3 is enabled to query the control information storage part 4 for control information corresponding to subsequently stored vendor codes. Moreover, the control part 3 is provided with a CEC modulation-demodulation unit 34. When the vendor acquisition instruction unit 31 queries the connected CEC device MA for the vendor code, the CEC modulation-demodulation unit 34 is enabled to output via the demodulation interface IF to the CEC device MA a signal instructing that the vendor code be output. Moreover, similarly, after the control part main body 33 has acquired control information from the vendor code stored in the storage unit 32 and from the instruction signal inputted from the photoreceptor unit 2 that has been stored in the control information storage part 4, the CEC modulation-demodulation unit 34 modulates the control information so that the control information can be received by the CEC device MA, and configures the control information so that the control information can be output.

### Embodiment 1

Embodiments of the present invention are described below with reference to drawings.

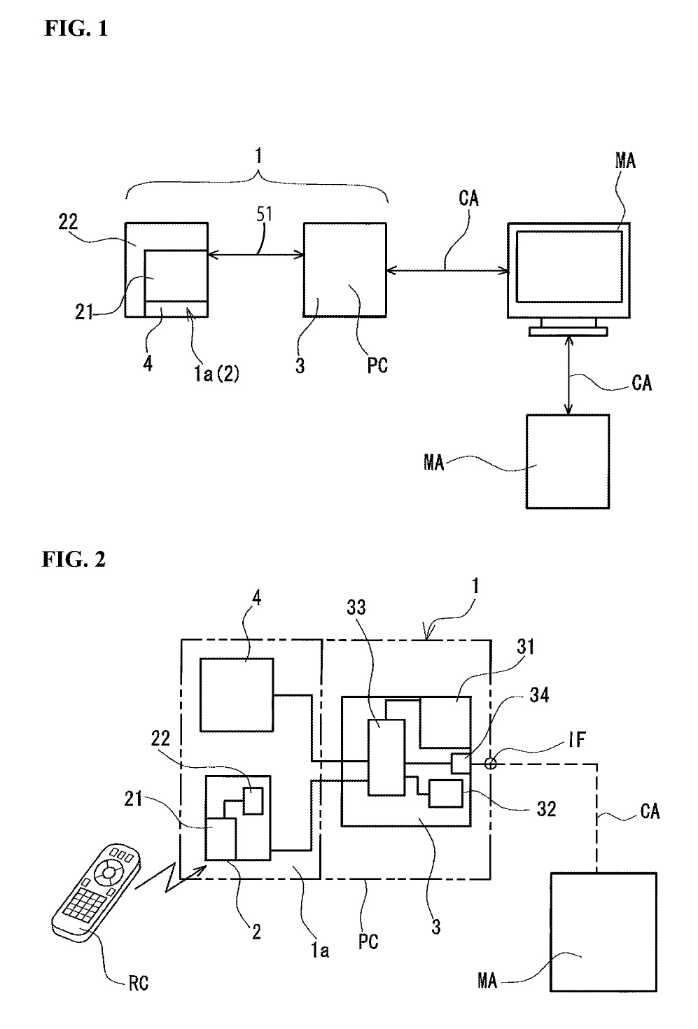

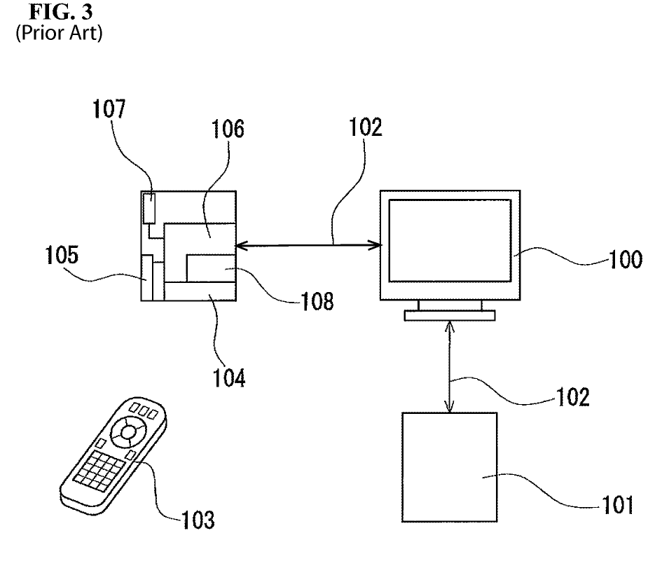

Reference numeral 1 denotes a CEC control apparatus, which represents an embodiment of the present invention. As shown in FIG. 1, the CEC control apparatus 1 is externally connected via a USB connection 51 to a personal computer PC so as to be coupled with the personal computer PC, and is formed as an apparatus for controlling a CEC device MA. Furthermore, in the description of this embodiment, the function of the personal computer PC for operating in accordance with an OS and application software is already known and therefore is not described herein, but the functions provided to devices, connected externally or connected to the motherboard, for operating in accordance with the CPU, memory, hard disk, display, various interfaces and the like provided in the PC are demonstrated, and coupled with the personal computer PC, these functions perform various processes. Accordingly, the CEC control apparatus 1 is configured together with the personal computer PC, and is provided with the functions of the personal computer PC, and is provided externally or internally with the functions lacking in a personal computer PC. Of course, the CEC control apparatus 1 may also be alternatively configured as a stand-alone apparatus, or as in the case of a personal computer PC, may be incorporated into the CEC device MA and configured together with the means provided to the CEC device MA.

As illustrated in FIG. 2, the CEC control apparatus 1 that functions integrally with the personal computer PC is connected to the CEC device MA via an interface IF provided on the personal computer PC and that provides CEC standard-compliant functionality. In other words, the CEC control apparatus 1 is connected via an HDMI cable CA to an HDMI terminal equipped with CEC functions. Thus, as described above, the CEC control apparatus 1 is configured from the personal computer PC and a CEC control apparatus main body 1a. The CEC control apparatus main body 1a is comprised of a photoreceptor unit 2 and a control information storage part 4.

The photoreceptor unit 2 comprising a portion of the CEC control apparatus 1a has a photoreceiving part 21 capable of continuously receiving optical signals transmitted from the remote control RC, and an instruction signal decode part 22 which is an instruction signal demodulation means capable of continuously monitoring whether the photoreceptor unit 2 has received an optical signal and, in the case where an optical signal has been received, of analyzing the received signal and demodulating the received signal into an instruction signal, both the photoreceiving part 21 and the instruction signal decode part 22 being connected so as to enable the transmission and reception of information, and the instruction signal decode part 22 being connected in a manner that enables output of the decoded instruction signal. Accordingly, at the photoreceptor unit 2, monitoring is performed continuously for the existence of transmissions from the remote control RC, and when a transmission is received, the instruction signal decode part 22 demodulates the received signal and demodulates the instruction signal included in the received signal, and the demodulated signal can be output to the control part 3.

The present invention has been described with infrared signals being outputted from the remote control RC, and therefore has a photoreceiving part 21. However, alternatively, electromagnetic waves of a different bandwidth may also be used. In such a case the photoreceiving part 21 functions as a signal receiving part, and the photoreceiving part 21 is formed with a means capable of receiving signals from the remote control RC.

As shown in FIG. 2, the CEC control apparatus main body 1a is provided with the control information storage part 4. The control information storage part 4 is a memory that is connected to the control part 3, and, in response to being referenced for stored information from the control part 3, can output stored information to the control part 3. Control information corresponding to the signals decoded at the photoreceptor unit 2 is pre-stored in the control information storage part 4. The control information stored in the control information storage part 4 is information that enables control of the CEC device MA, and for each vendor specified by the vendor code of the CEC device MA, control information linked to that vendor code is stored. At the control information storage part 4, from among the various stored control information linked to vendor codes that provide guidance when being referenced by the control part 3, control information corresponding to the instruction signal decoded by the photoreceptor unit 2 and outputted to the control part 3 is read out.

The control information stored in the control information storage part 4 is information that differs for each vendor as specified by a vendor code. For example, a vendor code for turning ON a power supply will generally not be recognized by devices other than those manufactured by the specified vendor as a control code for turning ON a power supply. Accordingly, unless control information that matches the vendor specified by the vendor code is output, the CEC device MA cannot be controlled properly. Thus, control information for each vendor code is stored in the control information storage part 4. Each piece of control information is linked to a vendor code and stored. Accordingly, the desired control information, having been linked to a vendor code and stored, is output from the control information storage part 4 so that the CEC device MA can be controlled properly according to that outputted control information.

Reference numeral 3 denotes the control part. In embodiment illustrated in FIG. 2, the control part 3 is formed from a CPU provided in the personal computer PC, a memory connected to the CPU, and the like. The control part 3 is provided with a CEC standard-compliant interface IF that can be connected to a CEC device MA. The interface IF can be connected via a HDMI cable so that signals can be exchanged with the CEC device MA.

The control part 3 is also connected to the CEC control apparatus main body 1a so that signals can be exchanged therebetween. This connection, made preferably via a USB connection and a CEC communication-capable connection, enables the exchange of signals with the photoreceptor unit 2 and control information storage part 4.

The control part 3 is provided with a vendor code acquisition instruction unit 31 that instructs the CEC device MA, which is externally connected to the interface IF, to output the vendor code. Additionally, the control part 3 is provided with a storage unit 32 that temporarily stores vendor codes acquired from the externally connected CEC device MA in response to an instruction from the vendor code acquisition instruction unit 31. The control part 3 is additionally provided with a control part main body 33, and the control part main body 33 is connected so that signals can be exchanged with the vendor code acquisition instruction unit 31 and the storage unit 32.

In this manner, since the connected interface IF is connected to the externally provided CEC device MA, the control part 3 is also connected to the externally provided CEC device MA. When the CEC device MA is connected, the control part 3 is able to receive a carrier signal issued by the CEC device MA. This carrier signal is predetermined by the CEC standard, and is issued through the CEC interface while the CEC device MA is connected so as to enable recognition that CEC devices MA are connected with one another. Accordingly, at the control part 3, when a connection is made with the CEC device MA, the connection with the CEC device MA is recognized automatically.

The vendor code acquisition instruction unit 31, having pre-stored the signal for instructing the CEC device MA to output its own vendor code, instructs the CEC-connected CEC device MA to output its own vendor code, and as a result, the signal can be output in response to the instruction from the control part main body 33. This vendor code output instruction signal is output from the control part main body 33, through the interface IF to the externally connected CDC device MA. At this time, the vendor code output instruction signal output from the vendor code acquisition unit 31 is modulated by a CEC modulation-demodulation unit 34 in accordance with the CEC standard, and is output via the interface IF.

The storage unit 32 is enabled, in response to an instruction from the control part main body 33, to store the CEC device MA vendor code that has been accepted via the CEC connection as a result of an output instruction from the vendor code acquisition instruction unit 31, and is also enabled to output the vendor code stored in response to the instruction from the control part main body 33. This storage signifies that the vendor code is written by the control part main body 33, and similarly, that the output vendor code is read out by the control part main body 33. Furthermore, in this embodiment, it has been explained that after the vendor code is read out by the control part main body 33, the control information storage part 4 is referenced for the control information that has been accepted by the photoreceptor unit 2, but specifically, the control part main body 33 compares the acquired vendor code with pre-prepared table data, specifies the corresponding data, and stores in the storage unit 32 the location of the control information storage part 4 at which control information corresponding to the acquired vendor code is stored, and then references the storage area of the control information storage part 4 stored in the storage unit 32. Accordingly, the storage unit 32 stores the reference location of the control information stored in the control information storage part 4 that corresponds to the acquired vendor code.

When the control part main body 33 acquires a carrier signal after the externally connected CEC device MA has completed the CEC connection, the control part main body 33 causes a vendor code acquisition instruction signal to be output from the vendor code acquisition instruction unit 31 in order to acquire a vendor code. Moreover, the control part main body 33 accepts and stores in the storage unit 32 the vendor code that the vendor code acquisition instruction unit 31 had instructed to be output. In this manner, the vendor code is transmitted from the CEC device MA and acquired at the control part 3. Then, the acquired vendor code is stored in the storage means 32 in the control part 3. After storing the vendor code, the storage unit 32 provided in the control part 3 can query the control information storage part 4 for control information corresponding to subsequently stored vendor codes.

Moreover, the control part main body 33 is capable of inputting an instruction signal outputted from the photoreceptor unit 2, and when an instruction signal is input thereto, the control part main body 33 reads out the vendor code stored in the storage unit 32 and queries the control information storage part 4, from among the stored control information linked to that vendor code, for the control information corresponding to the instruction signal acquired from the photoreceptor unit 2, and causes the control information storage part 4 to output that control information. In other words, the control part main body 33 is capable of reading from the control information storage part 4.

Moreover, the control part 3 is provided with a CEC modulation-demodulation unit 34. This CEC modulation-demodulation unit 34 is capable of inputting the vendor code output instruction signal outputted from the vendor code acquisition unit 31, is connected to the control part main body 33 so as to be able to input control signals acquired from the photoreceptor unit 2 and is connected to the interface IF, and when signals are transmitted through the interface IF, is capable of performing modulation and demodulation in compliance with the CEC standard. In response to an instruction outputted from the control part main body 33 to the connected CEC device MA, the vendor code acquisition unit 31 accepts a vendor code output instruction signal; the signal is modulated to a CEC-standard compliant signal, and the modulated vendor code output instruction signal is output through the interface IF connected to the CEC modulation-demodulation unit 34 to the externally connected CEC device MA to be controlled. Moreover, the CEC modulation-demodulation unit 34 is connected to the control part main unit 33, and after the control part main 33 inputs an instruction signal from the photoreceptor unit 2 and then references the control information storage part 4 for control information and acquires the control information corresponding to the vendor code, the CEC modulation-demodulation unit 34 can modulate and output the control information as a transmission signal that can be received by the CEC device. Moreover, also when the vendor code acquisition instruction unit 31 queries the CEC device MA, the CEC modulation-demodulation unit 34 can implement modulation in compliance with the CEC standard and output a vendor code acquisition instruction signal for querying the vendor code. Furthermore, in this embodiment, the CEC modulation-demodulation unit 34 is described as having a single unit capable of modulation and demodulation, but may also be configured with separate CEC modulation unit and separate CEC demodulation means. Additionally, the CEC modulation-demodulation unit 34 is described as being connected to the control part main body 33 and as inputting from the control part main body 33 the vendor code output instruction signal outputted from the vendor code acquisition unit 31 or the instruction signal acquired by the photoreceptor unit 2, but may also be configured as connected directly to the photoreceptor unit 2 and the vendor code acquisition unit 31.

Additionally, the control part main body 33 is capable of outputting the control information read from the control information storage part 4 through the interface IF to the externally connected CEC device MA. The control information output at this time is a control command capable of controlling the CEC device MA appropriately.

In the CEC control apparatus 1 configured as described above, when the CEC device MA is connected to the interface IF, the control part main body 33 acquires a carrier signal from the externally connected CEC device MA. When the control part main body 33 acquires the carrier signal, the control part main body 33 causes the vendor code acquisition instruction unit 31 to output information causing the vendor code acquisition instructions unit 31 to instruction the acquisition of the vendor code.

In accordance with this instruction, the vendor code acquisition instruction unit 31 outputs a vendor code acquisition instruction signal via the control part main body 33 and the interface IF to the externally connected CEC device MA. At this time, the CEC modulation-demodulation unit 34 is able to modulate in compliance with the CEC standard and output a vendor code acquisition instruction signal for querying the vendor code.

Thereupon, the externally connected CEC device MA inputs the vendor code acquisition instruction signal, and in accordance with the signal, outputs the vendor code.

The output of vendor code information corresponding to the output of the vendor code acquisition instruction signal as described above, is an already known technique that is already normally performed at the CEC device MA, and therefore is not described in detail herein.

The vendor code information outputted from the CEC device MA is acquired via the interface IF by the control part main body 33. The control part main body 33 causes the accepted vendor code to be stored in the storage unit 32. The vendor code stored in the storage unit 32 is read out by the control part main body 33.

When the user operates the remote control RC to operate the CEC device MA, a control signal is output from the remote control RC. This control signal is a command such as, for example, power supply ON/OFF, or play, stop, fast forward, fast rewind, pause, etc.

The control signal outputted from the remote control RC is received by the photoreceiving part 21 of the photoreceptor unit 2. At the photoreceptor unit 2, the instruction signal decode part 22 accepts and decodes the reception signal received by the photoreceiving part 21 to acquire the instruction signal. Then, the acquired instruction signal is output to the control part 3.

Namely, for example, if the photoreceptor unit 2 receives the “start” signal generated when the start button is pressed on the remote control RC, at the photoreceptor unit 2, the photoreceiving part 21 receives and outputs to the instruction signal decode part 22 a reception signal indicating the “start” instruction. At the instruction signal decode part 22, the accepted “start” reception signal is decoded and an instruction signal indicating “start” is output to the control part 3.

At the control part 3, the control part main body 33 accepts that signal. Upon receiving the instruction signal from the photoreceptor unit 2, the control part main body 33 reads out the vendor code from the storage unit 32, and references the control information storage part 4 for the control information. In other words, the control part main body 33 reads out control information that is linked to the vendor code and stored in the control information storage part 4.

Next, the control part main body 33 modulates by means of the CEC modulation-demodulation unit 34 and outputs, via the interface IF to the externally connected CEC device MA, the control information read out and acquired from the control information storage part 4.

Thereupon, the CEC device MA that has accepted the control information performs an operation based on the control information.

The CEC control apparatus 1 in the above-described embodiment was described as being configured from a CEC control apparatus main body 1a that is externally connected to a personal computer PC and to the CEC device MA. A configuration that does not depend on the CEC control apparatus main body 1 a and the personal computer PC may also be used as shown in FIG. 1, wherein the CEC control apparatus 1 is configured irrespective of the personal computer PC and connected to the personal computer PC via an appropriate method such as a CEC connection (not shown) or a USB connection 51, and a CEC device MA connected externally to the personal computer is controlled via the personal computer PC. Similarly, the CEC control apparatus 1 may also be configured alone and connected directly to the CEC device MA so as to be able to control the CEC device MA, or may be configured as incorporated into the CEC device MA (including the case in which some functions are shared with the CEC device MA) and used as a part of the CEC device MA, in both cases being provided with the photoreceptor unit 2, the control part 3 and the interface IF.

The aforementioned embodiment as illustrated in FIG. 2 was configured such that a vendor code acquired via the vendor code acquisition instruction unit 31 from the connected CEC device MA is stored in the storage unit 32, and when the photoreceptor unit 2 acquires an instruction signal based on a signal from the remote control RC, then based on the vendor code stored in the storage means 32 and the instruction signal, the control information storage part 4 is queried for control information to control the CEC device MA and that control information is acquired. However, in the alternative embodiment described below, when a vendor code is inputted from the CEC device MA, an area linked to the vendor code and stored within the storage area of the control information storage part 4, or in other words, a control information reference area, is pre-stored in the storage unit 32, and when the photoreceptor unit 2 acquires an instruction signal from the remote control RC, that storage area is referenced based on the vendor code.

In other words, the configuration of the previous embodiment of FIG. 2 is similar to that of the alternative embodiment, but the storage unit 32 does not store the vendor code acquired by the vendor code acquisition instruction unit 31. Instead, when the vendor code is acquired by the vendor code acquisition instruction unit 31 at a control part 3, the storage unit 32 can store the reference location of the stored CEC control information that corresponds to the vendor code. This reference location is stored as a reference site that pre-stores in the control information storage part 4 CEC control information corresponding to a plurality of vendors, each vendor being specified by a vendor code.

Accordingly, at the control part 3, when control information corresponding to an instruction signal acquired based on a signal the photoreceptor unit 2 has received from the remote control RC is accepted, the storage area for referencing the control information storage part 4 is acquired from the storage unit 32, and control information is acquired from this area.

Accordingly, there are a variety of suitable methods with which the control part 3 may query the control information storage part 4 for control information, based on the vendor code acquired by the vendor code acquisition instruction unit 31 and the instruction signal acquired by the photoreceptor unit 2. Any method may be used as long as the control information corresponding to the acquired vendor code is acquired from the control information storage part 4.

It is within the intended scope of the present invention to include all foreseeable equivalents to the elements described herein with reference to FIGS. 1 and 2. The examples described herein in reference to the several embodiments of the invention are not to be interpreted as limiting the invention beyond that which is claimed.

1. A CEC control apparatus that receives a control signal transmitted from a remote controller, specifies a CEC device control signal from the received control signal, and is capable of communicating with a CEC device, the CEC control apparatus comprising:
a connecting interface for connecting to the CEC device so that CEC control signals can be exchanged;
a CEC modulation-demodulation unit capable of modulating and demodulating a CEC control signal that communicates with the CEC device to be controlled via the interface;
a vendor code acquisition instruction unit capable of querying the CEC device upon being connected for its vendor code, and capable of acquiring the vendor code transmitted from the CEC device;
a control part provided with a storage unit capable of storing the acquired vendor code;
a control information storage part, connected so as to be able to exchange signals with the control part, and having pre-stored CEC control information for a plurality of vendors, each vendor being specified by a vendor code;
a receiving unit, connected so as to be able to exchange signals with the control unit, for receiving control signals transmitted from the remote controller; and
a photoreceptor unit comprising a received signal demodulation unit capable of accepting and demodulating control signals received by the receiving unit and acquiring CEC control signals;
the control part configured to acquire, based on the vendor code stored in the storage means and control signal received by the photoreceptor unit, CEC control information corresponding to the CEC device to be controlled and stored in the control information storage part, modulate the CEC control information with the CEC modulation-demodulation unit, and transmit the modulated CEC control information via the connecting interface to the CEC device.

2. A CEC control apparatus that receives a control signal transmitted from a remote controller, specifies a CEC device control signal from the received control signal, and is capable of communicating with a CEC device, the CEC control apparatus comprising:
a connecting interface for connecting to the CEC device so that CEC control signals can be exchanged;
a CEC modulation-demodulation unit capable of modulating and demodulating a CEC control signal that communicates with the CEC device to be controlled via the interface;
a vendor code acquisition instruction unit capable of querying the CEC device upon being connected for its vendor code and capable of acquiring the vendor code transmitted from the CEC device;
a control part provided with a storage unit capable of storing the acquired vendor code;
a control information storage part, connected so as to be able to exchange signals with the control part, and having pre-stored CEC control information for a plurality of vendors, each vendor being specified by a vendor code;
a receiving unit, connected so as to be able to exchange signals with the control part, for receiving control signals transmitted from the remote controller; and
a photoreceptor unit comprising a received signal demodulation unit capable of accepting and demodulating control signals received by the receiving unit and acquiring CEC control signals;
wherein at the control part, storing the acquired vendor code of a connected CEC device in the storage unit of the control part enables the corresponding CEC control information to be acquired from the control information storage part; and
wherein when the photoreceptor unit receives a control signal from the remote controller, demodulates the received signal, acquires a control signal, and outputs the control signal to the control part, based on the accepted control signal and the previously acquired and stored vendor code of the CEC device to be controlled, the control part selects and accepts from the control information storage part CEC control information corresponding to the CEC device to be controlled, modulates the CEC control information with the CEC modulation-demodulation unit, and is capable of transmitting the modulated CEC control information via the connecting interface to the CEC device.

3. A CEC control apparatus that receives a control signal transmitted from a remote controller, specifies a CEC device control signal from the received control signal, and is capable of communicating with a CEC device, the CEC control apparatus comprising:
a connecting interface for connecting to the CEC device so that CEC control signals can be exchanged;
a CEC modulation-demodulation unit capable of modulating and demodulating a CEC control signal that communicates with the CEC device to be controlled via the interface;
a vendor code acquisition instruction unit capable of querying the CEC device upon being connected for its vendor code and accepts the vendor code transmitted from the CEC device;
a control part provided with a storage unit capable of storing a reference location of CEC control information stored in correspondence to the acquired vendor code;
a control information storage part, connected so as to be able to exchange signals with the control part, and having pre-stored CEC control information for a plurality of vendors, each vendor being specified by a vendor code;
a receiving unit, connected so as to be able to exchange signals with the control part, for receiving control signals transmitted from the remote controller; and
a photoreceptor unit comprising a received signal demodulation unit capable of accepting and demodulating control signals received by the receiving unit and acquiring CEC control signals;
wherein at the control part, storing the storage site of the control information storage part, which records the CEC control information corresponding to the vendor specified by the vendor code acquired from the connected CEC device, in the storage unit of the control part enables the corresponding CEC control information to be acquired from the control information storage part; and
when the photoreceptor unit receives a control signal from the remote controller, demodulates the received signal, acquires a control signal, and outputs the control signal to the control part, based on the accepted control signal and the previously acquired and stored vendor code of the CEC device to be controlled, the control part selects and accepts from the control information storage part CEC control information corresponding to the CEC device to be controlled, modulates the CEC control information with the CEC modulation-demodulation unit, and is capable of transmitting the modulated CEC control information via the connecting interface to the CEC device.
